(19) United States
(12) Patent Application Publication
(10) Pub. No.: US 2008/0204588 A1
(43) Pub. Date: Aug. 28, 2008

(54) Image-Recording System

(76) Inventors: Werner Knee, Esslingen (DE); Tobias Stumber, Stuttgart (DE)

Correspondence Address: KENYON & KENYON LLP, ONE BROADWAY, NEW YORK, NY, 10004, US

(21) Appl. No.: 11/632,262

(22) PCT Filed: May 24, 2005
(86) PCT No.: PCT/EP2005/052379

§ 371 Date: Dec. 21, 2007

(30) Foreign Application Priority Data
Jul. 10, 2004 (DE) 102004033481.1

(51) Int. Cl. H04N 5/225

(52) U.S. Cl. 348/335; 348/E05.024

(57) ABSTRACT

The present invention relates to an image-recording system having an optical module and a control unit, the optical module including a programmable logic module and the control unit including control means for the configuration of the logic module.

### FIELD OF THE INVENTION

The present invention relates to an image-recording system and to a method for controlling an image-recording system.

### BACKGROUND INFORMATION

From German Patent No. 696 17 150, a mechanical optical recognition system for the inspection of containers is known, which includes a camera for recording an image, a preprocessor for receiving pixel data from the camera and the carrying out of selected preprocessing operations on it, and a main processor for carrying out an image analysis on the preprocessed pixel data received from the preprocessor. The preprocessor has a system of hardware logic elements which are variably configurable (FPGA—field programmable gate array), so that the preprocessing hardware may easily be reprogrammed or reconfigured for the execution of different preprocessing operations. A digital memory is also provided in which configuration programs are stored for the programmable logic device. The preprocessor reacts to control signals from the main processor, in order selectively to vary the configuration of the hardware logic elements. The digital memory for recording the configuration programs for the hardware logic elements requires space on the printed circuit board of the image-recording system, and represents an additional cost factor.

### SUMMARY OF THE INVENTION

The present invention makes possible a small cost-effective construction of an image-recording system, which is therefore particularly advantageous for installation in a motor vehicle. The small size of the image-recording system is important for such applications, because it is frequently to be positioned in the area of the windshield of the vehicle for forward viewing applications. It is clear that, in addition, the price for an application in mass production is an important sales argument.

The present invention relates to the knowledge that programming of a logic module (FPGA) that is situated structurally adjacent, in an optical module, to an image sensor, may take place expediently also by control by a control unit of the image-recording system that is locally removed from the optical module. The image-recording system is able to be controlled into a configuration mode and an operating mode particularly advantageously, for this purpose. In this context, the logic module is configured in the configuration mode, while in the operating mode data are transmitted between the optical module and the control unit of the image-recording system. Particularly advantageously, the optical module and the control unit of the image-recording system are connected to each other by connecting means which include a cable including a plurality of conductors. In order to keep the circuit technology expenditure as low as possible, individual conductors, in this context, have allocated to them several functions which are actively controlled partially in the configuration mode and partially in the operating mode of the image recording unit. Advantageously, in the operating mode, those connections are switched to be highly resistive which were active in the configuration mode, in order to avoid interferences.

In one advantageous method, for controlling an image-recording system which includes an optical module having a programmable logic module and a control unit having control means for the logic module, after each power-on, the image-recording system is first routed into a configuration mode and only subsequently into an operating mode. In this context, the logic module is configured in the configuration mode, while in the operating mode data are transmitted between the optical module and the control unit of the image-recording system.

### BRIEF DESCRIPTION OF THE DRAWINGS

FIG. 1 shows a block diagram of an image-recording system.

FIG. 2 shows a block diagram of the image-recording system drawn in greater detail.

### DETAILED DESCRIPTION

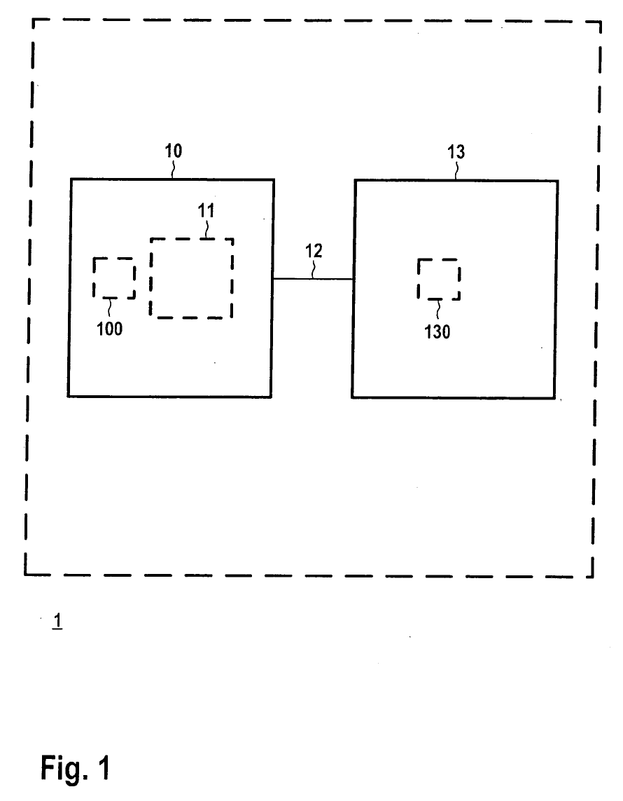

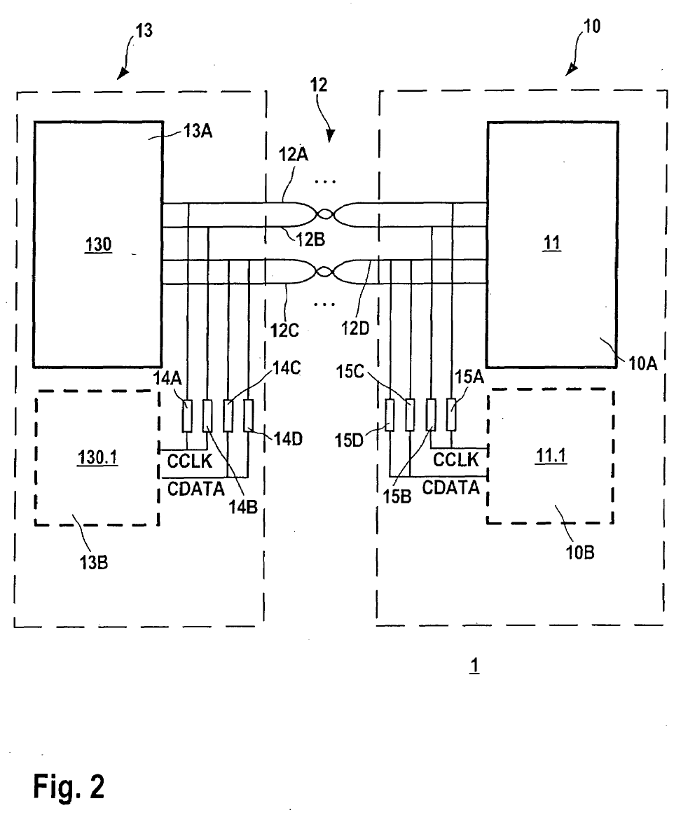

FIG. 1 illustrates a block diagram of an image-recording system 1 designed according to the present invention. Image-recording system 1 includes an optical module 10. Optical module 10, in turn, includes an image sensor 100, particularly a CCD camera (CCD=charge-coupled device) having an appertaining electronic wiring configuration, as well as being structurally combined with image sensor 100, especially being integrated on a common printed circuit board, a programmable logic module 11, particularly a so-called FPGA (field programmable gate array). Image-recording system 1 also includes a control unit 13 which is preferably locally removed from optical module 10 and is connected to it by connecting means 12. Such an image-recording system is very expediently installed in a motor vehicle as a component of a driver assistance system. In this function, image-recording system 1 records optical signals, especially images of the environment of the vehicle, which are evaluated for the vehicle control and/or the generation of warning signals for the driver. Therefore, optical module 10 of image-recording system 1 is preferably fastened to the windshield of the vehicle, whereas control unit 13, locally removed from it, may be positioned in its own place, at a suitable place in the passenger compartment of the vehicle. Control unit 13 is used to control optical module 10, and includes particularly control means 130 for controlling logic module 11. Logic module 11 is a semiconductor module preferably produced in an SRAM process, which has volatile memory properties. This means that logic module 11 has to be newly configured, after every power-off and power-on, with its intended function. This configuration of logic module 11 is advantageously carried out by control means 130 that are provided in control unit 13. Control means 130 expediently make available for this control signals originating from a digital nonvolatile memory, which are supplied via connecting means 12 to logic module 11. In order to save space and costs, a usual type of cable made up of a plurality of conductors 12A, 12B, 12C, 12D is used as connecting means 12, the individual conductors of the cable being assigned several functions depending on the particular operating mode. This will be described in detail below, with reference to the block diagram of image-recording system 1 shown in greater detail in FIG. 2. In the case of image-recording system 1, one may distinguish an operating mode 10A, 13A and a configuration mode 10B and 13B. This is made clearer in the block diagram in FIG. 2b in that control means 130, 130.1 in control unit 13 and logic module 11, 11.1 in optical module 10 are drawn in in each case once as a block having a continuous line and once as a block having a dashed line. The blocks drawn in with the continuous line correspond to the operating mode, while those drawn in with the dashed line correspond to the configuration mode. Control unit 13 and optical module 10, as was mentioned before, are connected to each other via connecting means 12. Connecting means 12 is made up of a cable including conductors 12A, 12B, 12C, 12D. The conductors of the cable are assigned multiple functions depending on the respective mode of image-recording system 1. Conductors 12A, 12B, 12C, 12D are connected both to control unit 13 and to optical module 10 at least two different pins. Thus, the conductors are connected, on the one hand, to pins for the configuration (CCLK) of logic module 11, and on the other hand, to the pins for the transmission of the data (CDATA) obtained from optical module 10. The pins assigned to the respectively inactive mode are switched to be highly resistive, and they then behave neutral with respect to the active mode.

The method of functioning of image-recording system 1 will be briefly elucidated below. It should first be assumed that after a power-on, image-recording system 1 is in the configuration mode (10B, 13B), in which the blocks drawn by a dashed line of control means 130.1 in control unit 13 and of logic module 11.1 in optical module 10 are active. For the renewed configuration of logic module 11.1 after a power-on, at least two signals are required, namely configuration clock (CCLK) and configuration data (CDATA). These signals are transmitted by control means 130.1 of control unit 13 via resistors 14A, 14B, 14C, 14D, conductors 12A, 12B, 12C, 12D and resistors 15A, 15B, 15C, 15D in the direction of optical module 10 to logic module 11.1 that is situated there. After the successful configuration of logic module 11.1, the line connections used for the configuration are switched to be highly resistive, and conductors 12A, 12B, 12C, 12D are used in the operating mode of image-recording system 1 for the data transmission between optical module 10 and control unit 13. Within the scope of this data transmission, control signals are transmitted from control unit 13 to optical module 10, and image data are transmitted from optical module 10 to control unit 13. For these data transmissions, LVDS signals (LVDS=low voltage differential signal) are expediently used. After the configuration mode it is expediently checked whether the configuration of logic module 11 has been successful. This may be established via a successful initialization of the image sensor in control unit 13. In order to improve the signal quality during the configuration of logic module 11, Schmitt triggers may also advantageously be integrated into the lines on the part of optical module 10.

1.-14. (canceled)

15. An image-recording system, comprising:
an optical module including a programmable logic module; and
a control unit including a control arrangement for configuring the logic module.

16. The image-recording system as recited in claim 1, further comprising:
a connecting arrangement by which the optical module and the control unit are connected to each other.

17. The image-recording system as recited in claim 1, wherein the image-recording system is able to be routed into a configuration mode and an operating mode.

18. The image-recording system as recited in claim 16, wherein:
the connecting arrangement includes a cable that includes a plurality of conductors that are able to be assigned a multiple function depending on an operating mode of the image-recording system.

19. The image-recording system as recited in claim 18, wherein configuration data for the logic module are able to be transmitted by the control arrangement to the optical module, in a configuration mode of the image-recording system, via the conductors of the connecting arrangement.

20. The image-recording system as recited in claim 18, wherein data signals are able to be transmitted via the conductors, in the operating mode of the image-recording system.

21. The image-recording system as recited in claim 18, wherein:
each conductor of the connecting arrangement is connected to a plurality of connecting pins, both in the control unit and in the optical module, in each case one pin being active in a configuration mode and another pin being active in the operating mode.

22. The image-recording system as recited in claim 21, wherein:
in the operating mode, connections switched active for the configuration mode between the conductors of the connecting arrangement and the pins are routed to be highly resistive.

23. The image-recording system as recited in claim 15, wherein the image-recording system is used in a motor vehicle.

24. The image-recording system as recited in claim 15, wherein the optical module is fastened to a window pane of a motor vehicle, especially to the windshield.

25. The image-recording system as recited in claim 15, wherein the optical module is fastened to a windshield of a motor vehicle.

26. The image-recording system as recited in claim 15, wherein the control unit is situated locally separated from the optical module.

27. A method for operating an image-recording system that includes an optical module having a programmable logic module and a control unit having a control arrangement for the logic module, the method comprising:
after a power-on, routing the image-recording system first to a configuration mode and subsequently to an operating mode.

28. The method as recited in claim 27, wherein the logic module is configured in the optical module, in the configuration mode.

29. The method as recited in claim 27, further comprising:
for the configuration of the logic module, transmitting control signals by the control arrangement from the control unit to the logic module.
